(19) United States
(12) Patent Application Publication
(10) Pub. No.: US 2011/0218876 A1
(43) Pub. Date: Sep. 8, 2011

(54) ONLINE SYSTEM AND METHOD FOR BRA RECOMMENDATIONS

(76) Inventor: Lisa Sorrentino, Chicago, IL (US)

(21) Appl. No.: 13/040,247

(22) Filed: Mar. 3, 2011

Related U.S. Application Data
(60) Provisional application No. 61/310,262, filed on Mar. 3, 2010.

(51) Int. Cl. G06Q 30/00

(52) U.S. Cl. 705/26.7

(57) ABSTRACT

An online bra recommendation system and method provide one or more customer specific size and style recommendations. The recommendations are based on a calculated customer specific bra size and one or more customer style preferences. The calculated customer specific bra size is based on customer measurements. The customer measurements may include a measurement above the bust, around the fullest part of the bust and around the ribcage, under the bust. The customer may be instructed as to how to take appropriate measurements. The recommendation may further be based on feedback regarding current bra size and fit issues. The recommendation may further be based on one or more feature selections. The information may be collected through an online system, the recommendation made by a professional and the recommendation communicated to the user through the online system.

### CROSS-REFERENCE TO RELATED APPLICATIONS

This application incorporates by reference and claims priority to U.S. Provisional Patent Application No. 61/310,262 filed Mar. 3, 2010.

### BACKGROUND OF THE INVENTION

The present subject matter relates generally to an online bra recommendation system and method. More specifically, the present invention relates to an online bra recommendation system and method for providing size and style recommendations based on user inputs.

An increasing number of consumers shop online for items of every kind, including for clothing. While often preferred for convenience, price and selection, online shopping for clothing can be difficult, particularly with respect to sizing issues. Both customer satisfaction and online retailer profits are highly dependant on customers being able to find and purchase appropriately sized and styled articles of clothing, while minimizing returns.

Amongst clothing, bras are one of the more difficult items to shop for online When shopping online, one must do their own fitting. However, manufacturers of bras use their own sizing schemes and, therefore, a person may not wear the same size from style to style. Unfortunately, the present systems and methods often make it difficult for customers to find the appropriate size and style of bra the first time without wasting time and money using the trial and error approach and without having to learn the differences between bra manufacturers sizing schemes.

Accordingly, a need exists for an online bra recommendation system and method as described and claimed herein.

### BRIEF SUMMARY OF THE INVENTION

The subject matter disclosed herein addresses these issues by providing a method and system that enables a user to provide inputs of: the customer's measurements, the customer's preferences; and the customer's current size and fit information and receive as outputs: bra sizing and style information.

An online bra recommendation system and method provide one or more customer specific size and style recommendations. The recommendations are based on a calculated customer specific bra size and one or more customer style preferences. The calculated customer specific bra size is based on customer measurements. The customer measurements may include a measurement above the bust, around the fullest part of the bust and around the ribcage, under the bust. The customer may be instructed as to how to take appropriate measurements. The recommendation may further be based on feedback regarding current bra size and fit issues. The recommendation may further be based on one or more feature selections.

In one example, the system and method provide a custom online bra fitting tool that provides the framework for each user to: (1) take three accurate upper body measurements based on instructions and illustrations provided via the online bra fitting tool; (2) submit the measurements electronically in combination with bra feature/style preferences and a description of fit problem or problems the user may currently experience; and (3) receive one or more recommendations, wherein each recommendation includes the appropriate bra size for the recommended product style. The system and method are adapted to meet the individual user's personal preferences while providing the user suggestions for an improved fit.

The system and method provide a custom bra fitting tool that enables users to find appropriate sizes and styles of bras without having to visit a store. Additionally, the system and method may help to solve any current bra fit problems for the visitor by taking those issues into account in providing recommendations.

In some embodiments of the online bra recommendation system and method, the receipt of measurements, analysis of the measurements and the recommendations provided are accomplished automatically without human intervention. In other embodiments of the system and method provided herein, certain functions and steps are accomplished with human input/interaction. For example, the analysis of the customer measurements and the review of any presented current fit issues and/or style preferences may be provided by a person that receives the customer measurements and other requested information through an online application. The personal review of the information presented enables the recommendations made to be more customized and/or be based on experienced advice.

Accordingly, in systems and method in which recommendations are made by a person, the system and method empower users to learn their measurements and communicate their preferences and fit problems to get customized solutions from experts in the field that understand the relationship between the measurements obtained and the differences between manufacturers sizing schemes. The system and method are adapted to teach users to learn the measuring process and make an educated fitting and purchase decision. This enables users to get the bra fit right the first time without wasting time and money using the trial and error approach and without having to learn the differences between bra manufacturers sizing schemes.

From the perspective of the user, the system and method are a convenience that saves time and money by offering free online customized solutions and recommendations. From the perspective of the provider of the system and the method, the custom bra fitting tool may generate additional sales leads, reduce product returns and increase website traffic by providing a free service.

An online bra recommendation system includes: a controller, a plurality of associated user interfaces and one or more associated databases. The system may be configured to provide an automated bra recommendation system.

A method for generating bra recommendations includes the steps of: providing instructions for acquiring customer measurements; receiving customer measurements; receiving customer preferences; receiving information concerning customer's current size and problems with current fit; using at least a portion of the information received to provide one or more bra recommendations, including size and style recommendations; and storing customer profile information.

A computer-readable medium having computer-executable instructions for use in an online bra recommendation system includes computer-executable instructions causing the system to perform the steps of: providing instructions for acquiring customer measurements; receiving customer measurements; receiving customer preferences; receiving information concerning customer's current size and problems with current fit; using at least a portion of the information received to provide one or more bra recommendations, including size and style recommendations; and storing customer profile information.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of an online bra recommendation system.

FIG. 2 is a flow chart of a method for generating automated bra recommendations.

FIG. 3 is a screen shot of an example of a user interface for an online bra recommendation system.

FIG. 4 is a screen shot of another example of elements of a user interface for an online bra recommendation system.

FIG. 5 is a flow chart illustrating an example of a bra fitting decision tree.

### DETAILED DESCRIPTION OF THE INVENTION

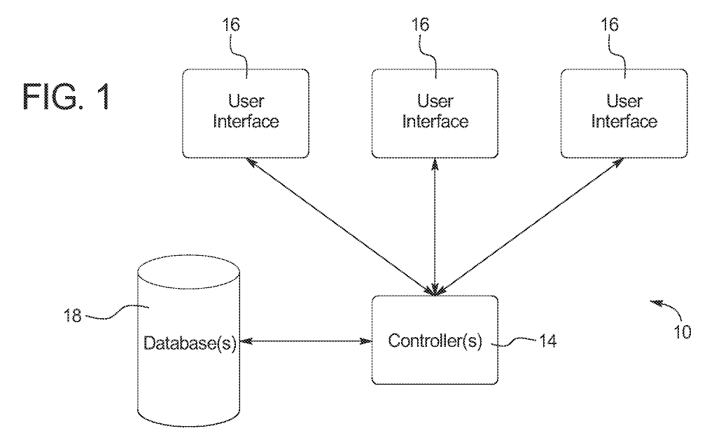

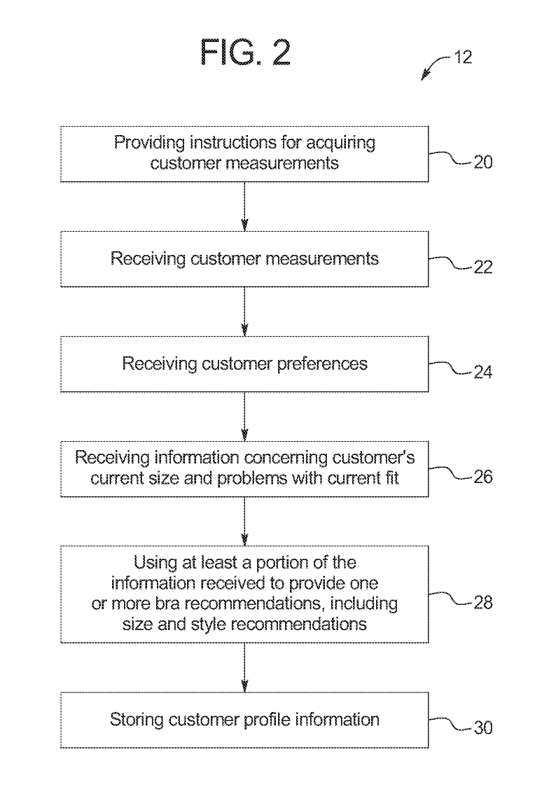

FIG. 1 depicts an online bra recommendation system 10 (the system 10). FIG. 2 illustrates a method for generating bra recommendations 12 (the method 12).

As shown in FIG. 1, the system 10 includes a controller 14, a plurality of associated user interfaces 16 and one or more associated databases 18. The controller 14 runs a variety of application programs, accesses and stores data, and enables one or more interactions via the user interfaces 16 provided. While further description of the controller 14 is provided below, it is understood that the controller 14 may be embodied in any one or more electronic systems arranged to control the electronic aspects of the system 10 and the method 12 described herein.

Users interact with the system 10 via respective user interfaces 16. For example, in the embodiment described with reference to FIG. 2, a customer interacts with the system 10 via a user interface 16. It is understood that one or more additional users may interact with the system 10 via additional user interfaces 16. Accordingly, it is understood that there may be any number of additional user interfaces 16 that may be utilized by any number of additional users. In certain embodiments of the system 10 described herein, there are two users, a customer and a recommender. Each may interact with the system 10 through a distinct user interface 16 and the user interfaces 16 may communicate with elements of the system 10 through the Internet or other communication means.

As shown in FIG. 1, the system 10 includes one or more databases 18. The one or more databases 18 store information relating to the operation of the system 10 and method 12 as described herein. The one or more databases 18 may be integrated with the controller 14 or may be independent of the controller 14. The structure and operation of the one or more databases 18 will be understood to one having ordinary skill in the art given the context of the description of the system 10 and the method 12 provided herein. Further, for purposes of this patent application, the phrase one or more databases 18 should be read to include any mechanism for storing, relating, organizing and retrieving data. It is also understood that in some contemplated embodiments of the system 10 and method 12 the information storage and relationships may be inherent in the programming code, without the use of one or more databases 18.

The system 10 shown in FIG. 1 may be adapted to provide an automated bra recommendation system as described further herein. In alternate embodiments, the system 10 may be adapted to receive information from a customer through an online interface, present the information to a recommender and enable the recommender to make a recommendation to the customer through the system 10.

Turning now to FIG. 2, the method 12 is shown including the following steps: providing instructions for acquiring customer measurements 20; receiving customer measurements 22; receiving customer preferences 24; receiving information concerning customer's current size and problems with current fit 26; using at least a portion of the information received to provide one or more bra recommendations, including size and style recommendations 28; and storing customer profile information 30. It is understood that the system 10 described herein may be adapted to accomplish the steps of the method 12 and, therefore, the following description references both the system 10 and the method 12.

As shown in FIG. 2, the first step in the method 12 is providing instructions for acquiring customer measurements 20. For example, the system 10 and method 12 may provide written or visual instructions for obtaining customer measurements that will be used in the recommendation process. For example, the processor 14 may cause the instructions to be displayed on a customer's user interface 16.

In one contemplated example, the step of providing instructions for acquiring customer measurements 20 includes providing instructions to obtain a first measurement below the bustline around the rib cage, a second measurement above the bustline under the armpits and a third measurement around the fullest part of the bustline. The instructions may include, for example, a graphical representation illustrating the measurement process and/or locations. Further, the graphical representation may be static or dynamic. It is understood that various embodiments may be provided wherein instructions are provided to obtain a greater or lesser number of measurements, which may increase or decrease the quality of the recommendations generated via the system 10 and method 12.

As further shown in FIG. 2, the step of receiving customer measurements 22 includes accepting information supplied by a customer regarding the customer measurements. The input may be menu selection driven or may include open data field inputs. In one example, a user supplies the customer measurements, as instructed to do in the step of providing instructions for acquiring customer measurements 20, via text input data fields displayed on the user interface 16.

The customer measurements may then be provided, for example, to the controller 14 via the user interface 16. Alternatively, the customer measurements may be provided to a recommender by the controller 14 through a user interface 16.

It is further contemplated that in some examples a data input tool (not shown) may be utilized to generate customer measurements and automatically submit them to the system 10. For example, such a data input tool may include one or more sensors for acquiring customer measurements and a transmitter for communicating the acquired measurements to the system 10, for example, via a user interface 16. In one contemplated example, the data input tool is an adjustable bra designed to adapt to various sizes and communicate the adapted size information to the system 10 (e.g., the bra may be fitted to the customer and, when appropriately fitted, a trigger may activate the sensors to acquire measurement data to be transmitted via the transmitter). Further, there may be, for example, a plurality of data input tools provided, wherein each data input tool is adaptable within a given range of sizes. Alternatively, in another contemplated embodiment, the data input tool may be, for example, an electronic measuring tape including one or more sensors and a transmitter.

Referring back to FIG. 2, the step of receiving customer preferences 24 may include receiving information from the customer regarding style preferences or other preferences. Again, the customer preferences may be provided, for example, to the controller 14 via the user interface 16, or the customer preferences 24 may be provided to a recommender via the controller 14 through a user interface 16. The input may be menu selection driven or may include open data field inputs. In one example, a user supplies the customer preferences via text input data fields displayed on the user interface 16.

In one example, the customer may select preferred styles by selecting from amongst displayed representative styles. Alternatively, the customer may provide customer preferences via menu selections. It is contemplated that customer preferences may include, colors, styles, materials, brands, prices, etc. The customer preferences may be prompted using multiple tiers of menus or selections. Further specific examples are provided in the attached Appendix.

As shown in FIG. 2, the step of receiving information concerning customer's current size and problems with current fit 26 may include receiving information from the customer regarding the customer's current bra size and any problems the customer may be having regarding the fit of the bra. The information may be provided, for example, to the controller 14 via the user interface 16. The information may be provided via menu driven selections or may include open data field inputs. In one example, a user supplies the input via on-screen menus displayed on the user interface 16.

It is contemplated that information received via the step of receiving information concerning customer's current size and problems with current fit 26 may include, for example: whether the customer is presently experiencing spillage out of the cups; whether the customer is presently experiencing the appropriate amount of restricted vertical movement, lift, separation, etc.; whether the customer is presently experiencing difficulty breathing; etc. In some contemplated examples, the information may be, for example, binary (e.g., yes or no), scaled (e.g., strongly agree, agree, neutral, disagree, strongly disagree) or otherwise logically arranged.

As shown in FIG. 2, the step of using at least a portion of the information received to provide one or more bra recommendations, including size and style recommendations 28 may include using any subset of the information collected in the previous steps, including the customer measurements, the customer preferences and the current size and fit information. The step of using at least a portion of the information received to provide one or more bra recommendations, including size and style recommendations 28 may be entirely automated by the controller 14 or it may include or rely upon user input from a recommender.

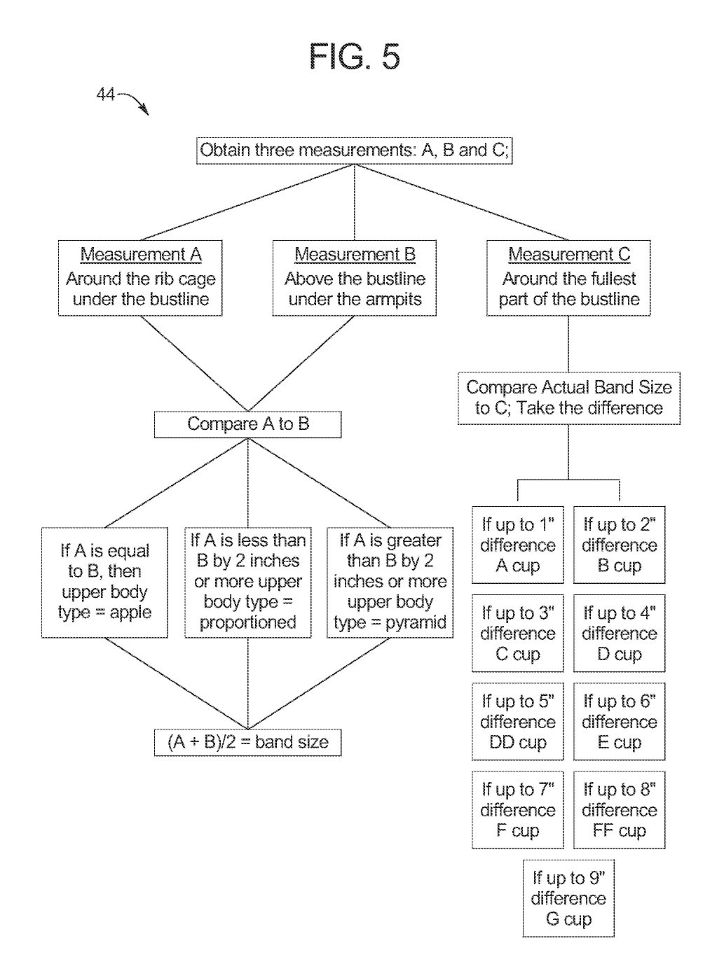

In one example, the customer measurements received may be used to determine a recommended size. The recommended size may be based on any method of fitting bras, an example of one contemplated method is provided in FIG. 5, as described below. The recommended size may then be modified using any current sizing and fit issues received (e.g., if the measurements received indicate a particular recommended size that matches the size provided as the current size of the user, but the user indicates the current size is problematic, the system may make appropriate adjustments to the recommended size to compensate) or in any other manner. For example, a recommender may make adjustments to the recommended size based on experience in fitting numerous women over time. The recommended size is then used to find matching inventory. The matching inventory is then further filtered using the customer preferences received. Finally, the filtered recommendations are provided to the customer, for example, by displaying the results on the user interface 16. Of course, this is merely one example of the ways in which the information collected via the system 10 and method 12 may be used according to the step of using at least a portion of the information received to provide one or more bra recommendations, including size and style recommendations 28.

It is understood that aspects of this step may be accomplished automatically via the system 10 or may require additional user input, including customer and/or third party input. For example, determining the appropriate recommended size from the customer measurements received may be accomplished automatically via the controller 14 and database 16 or it may include direction or input from a person, for example, through a second user interface 16.

The step of storing customer profile information 30, shown in FIG. 2, may include, for example, collecting and storing customer information including contact information, preferences, size information, etc. The step may include storing the collected information in a database 18 for future reference, statistical modeling, trending, etc.

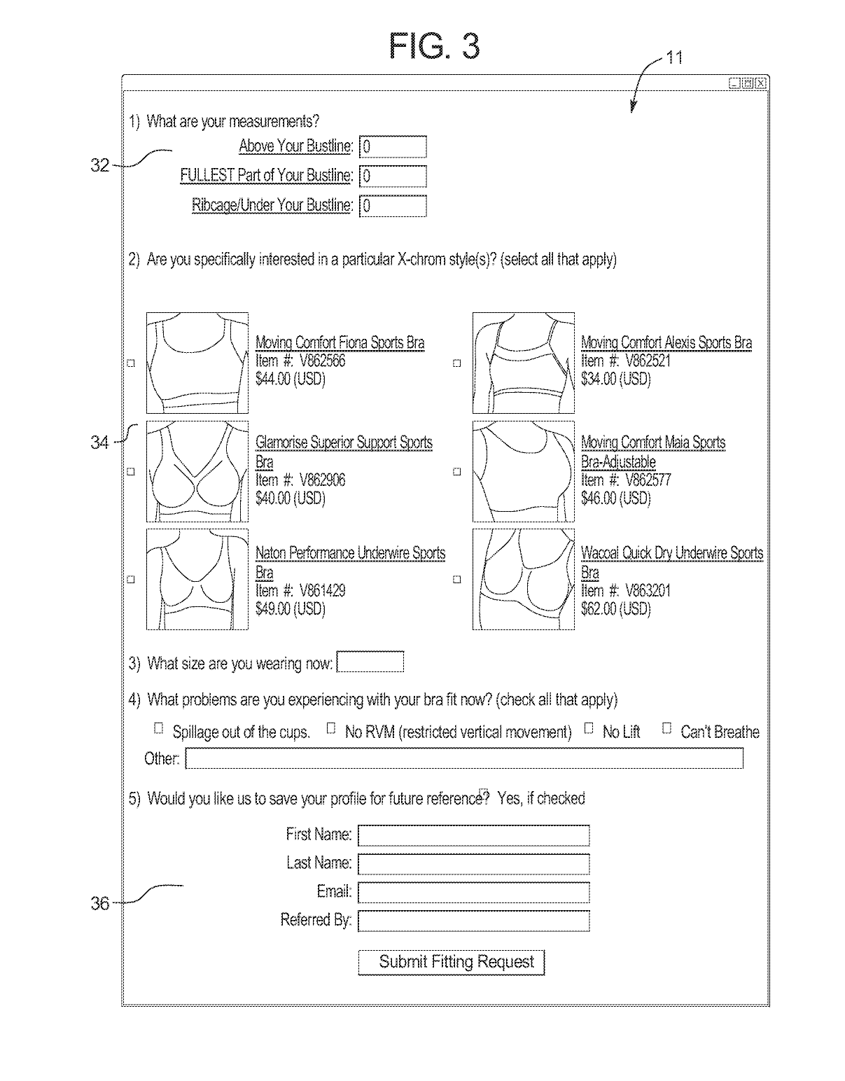

Turning now to FIG. 3, an example of an interface 11 for an automated bra recommendation system 10 is shown. As shown in FIG. 3, a user may enter specific customer measurements at a measurement entry section 32. As shown in FIG. 3, the measurement entry section 32 includes means for receiving three distinct customer measurements, including a measurement above the bust, around the fullest part of the bust and under the bust around the ribcage. Alternatively, a measurement entry section 32 may provide means for receiving a greater or lesser number of customer measurements.

As further shown in FIG. 3, the automated bra recommendation system 10 includes a style entry section 34. As shown in the style entry section 34, a customer may select one or more bra styles for which a recommendation is requested. In the example provided, there are six styles from which to choose, but it is understood that the system 10 may provide any number of styles from which to choose.

Below the style entry section 34 is a current fit section, through which a customer may provide information relating to the size bra the customer is currently wearing and any problems the customer may be experiencing with that particular size. For example, there may be selections for various common fit issues/problems, such as, spillage out of the cups, not enough restricted vertical movement, lack of lift, causing problems breathing, etc. Having predetermined selections for fit issues may help to automate the fit recommendation process. In addition, there may be a free form text entry section through which a customer can provide additional information regarding fit issues. Certain embodiments of the system 10 may be adapted to receive the free form text and automatically process the text for key words to be used in calculating the recommendation(s).

The last section shown in FIG. 3 is a customer information section 36 through which a customer may enter their information and select whether the system 10 is to store it for future use.

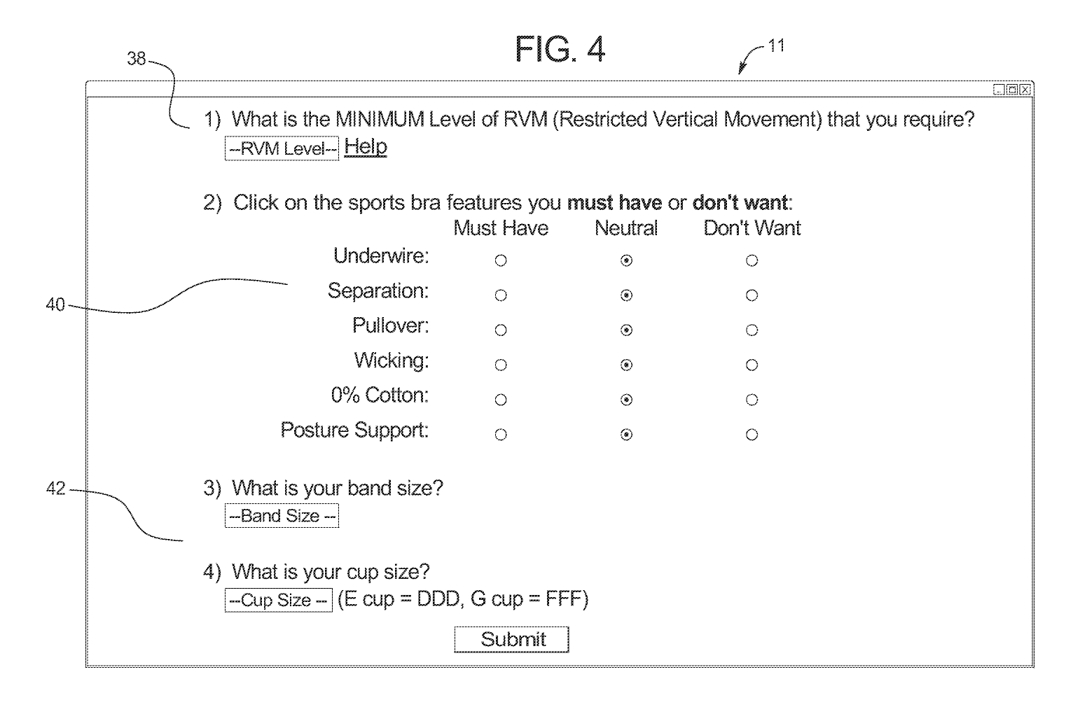

FIG. 4 illustrates additional information that may be collected from the customer to improve the recommendation made by the system 10. As shown in FIG. 4, there may be an RVM input 38 for the amount of restricted vertical movement desired by the customer. There may be further include a features selection input 40 for collecting information regarding the features desired by the customer. Additionally, a current size input 42 may be provided to collect additional information about the customer's current bra size.

FIG. 5 illustrates an example of a bra fitting decision tree 44. The example bra fitting decision tree 44 is merely one example of a bra fitting decision tree 44. It is understood that the number and identity of factors used in the bra fitting decision tree 44 will vary based on the system 10 implemented.

As shown in FIG. 5, the bra fitting decision tree 44 takes as its input three measurements: Measurement A (Around the rib cage under the bustline); Measurement B (Above the bustline under the armpits); and Measurement C (Around the fullest part of the bustline). Measurement A is compared to Measurement B. If Measurement A is equal to Measurement B, then the upper body type is identified as “apple.” If Measurement A is less than Measurement B by two inches or more, then the upper body type is identified as “proportioned.” If Measurement A is greater than Measurement B by two inches or more, then the upper body type is identified as “pyramid.” These upper body type identifications may be used in the system 10 to provide the automatic recommendations. In each case, the calculated band size is the sum of Measurement A and Measurement B divided by two.

As further shown in FIG. 5, the band size calculated using the average of Measurement A and Measurement B is compared to Measurement C. The difference between the calculated band size and Measurement C is used to calculate the cup size. As shown, if there is a one inch difference, the calculated cup size is A. If there is a two inch difference, the calculated cup size is B. If there is a three inch difference, the calculated cup size is C. If there is a four inch difference, the calculated cup size is D. If there is a five inch difference, the calculated cup size is DD. If there is a six inch difference, the calculated cup size is E. If there is a seven inch difference, the calculated cup size is F. If there is an eight inch difference, the calculated cup size is FF. If there is a nine inch difference, the calculated cup size is G.

Accordingly, as shown, the three measurements may be used to calculate both band size and cup size. In addition, the example of a bra fitting decision tree 44 shown in FIG. 5 can be used to calculate an upper body type, which may be used to improve the recommendations.

As shown by the above discussion, aspects of the automated bra recommendation system 10 are controlled by a controller 14. As described above, the controller 14 runs a variety of application programs, accesses and stores data, including accessing and storing data in associated databases 18, and enables one or more interactions via the user interfaces 16 provided. Typically, the controller 14 is implemented by one or more programmable data processing devices. The hardware elements operating systems and programming languages of such devices are conventional in nature, and it is presumed that those skilled in the art are adequately familiar therewith.

For example, the controller 14 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The controller 14 may also include one or more input/output interfaces for communications with one or more processing systems. Although not shown, one or more such interfaces may enable communications via a network, e.g., to enable sending and receiving instructions electronically. The physical communication links may be wired or wireless.

The controller 14 may further include appropriate input/output ports for interconnection with one or more output displays (e.g., monitors, printers, etc.) and one or more input mechanisms (e.g., keyboard, mouse, voice, touch, bioelectric devices, etc.) serving as one or more user interfaces 16 for the controller 14. For example, the controller 14 may include a graphics subsystem to drive the output display. The links of the peripherals to the system may be wired connections or use wireless communications.

Although summarized above as a PC-type implementation, those skilled in the art will recognize that the controller 14 also encompasses systems such as host computers, servers, workstations, network terminals, and the like. In fact, the use of the term controller 14 is intended to represent a broad category of components that are well known in the art.

Hence aspects of the system 10 and the method 12 discussed herein encompass hardware and software for controlling the relevant functions. Software may take the form of code or executable instructions for causing a controller 14 or other programmable equipment to perform the relevant steps, where the code or instructions are carried by or otherwise embodied in a medium readable by the controller 14 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any tangible medium that participates in providing instructions to a processor for execution. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other tangible medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An online bra recommendation system comprising:
a controller adapted to:
receive customer measurements including at least a first measurement of around the rib cage under the bust and a second measurement of around the fullest part of the bust;
communicate the customer measurements to a person to determine a customer specific bra size based on the measurements received; and
provide one or more customer specific size and style recommendations based on the determined customer specific bra size.

2. The system of claim 1 wherein the controller is further adapted to receive one or more customer style preferences.

3. The system of claim 2 wherein the controller is adapted to provide one or more customer style recommendations based on the one or more customer style preferences

4. The automated bra recommendation system of claim 1 wherein the customer measurements further include a third measurement above the bust.

5. The automated bra recommendation system of claim 1 wherein the controller is further adapted to provide instructions for making customer measurements.

6. The automated bra recommendation system of claim 1 further wherein the controller is further adapted to receive information regarding customer fit.

7. The automated bra recommendation system of claim 6 wherein the customer fit information includes problems the customer has experienced with a specific bra size.

8. The automated bra recommendation system of claim 1, wherein the customer style preference includes a restricted vertical movement selection.

9. The automated bra recommendation system of claim 1, wherein the customer style preference includes one or more feature selections.

10. A method of providing bra recommendations comprising the steps of:
receiving customer measurements from a first person through an online interface, wherein the customer measurements include at least a first measurement of around the rib cage under the bust and a second measurement of around the fullest part of the bust;
determining a customer specific bra size based on the measurements received, the determination being made, at least in part, by a second person who has received the customer measurements; and
providing through the online interface one or more customer specific size recommendations based on the determined customer specific bra size.

11. The method of claim 10 further including the step of receiving one or more customer style preferences from a first person through an online interface.

12. The method of claim 11 wherein the step of providing one or more customer specific size recommendations based on the determined customer specific bra size further includes and providing one or more customer specific style recommendations based on the one or more customer style preferences.

13. The method of providing automated bra recommendations of claim 10 wherein the customer measurements further include a third measurement above the bust.

14. The method of providing automated bra recommendations of claim 10 further including the step of providing instructions for making customer measurements.

15. The method of providing automated bra recommendations of claim 10 further including the step of receiving information regarding customer fit.

16. The method of providing automated bra recommendations of claim 15 wherein the customer fit information includes problems the customer has experienced with a specific bra size.

17. The method of providing automated bra recommendations of claim 10, wherein the customer style preference includes a restricted vertical movement selection.

18. The method of providing automated bra recommendations of claim 10, wherein the customer style preference includes one or more feature selections.
